(19) United States
(12) Patent Application Publication
(10) Pub. No.: US 2004/0266373 A1
(43) Pub. Date: Dec. 30, 2004

(54) Method and apparatus to control gain of a channel signal

(76) Inventor: Hyun-Wook Lim, Yongin-si (KR)

Correspondence Address: HARNESS, DICKEY & PIERCE, P.L.C., P.O. BOX 8910, RESTON, VA, 20195, US

(21) Appl. No.: 10/840,265

(22) Filed: May 7, 2004

(30) Foreign Application Priority Data
Jun. 30, 2003 (KR) 2003-43837

(51) Int. Cl. H04B 15/00

(52) U.S. Cl. 455/130

(57) ABSTRACT

An apparatus and method of controlling gain in a channel signal. The apparatus may include a gain compensating section that compensates a first gain therein based on the channel signal and a first gain control signal. The apparatus may include an equalizer for generating a gain signal based on the first compensating signal, the gain signal representing a second gain therein; and a gain compensating controller for generating, based on the gain signal, the first gain control signal for compensating the first gain.

### PRIORITY STATEMENT

This application claims priority under 35 USC § 119 to Korean Patent Application 2003-43837 filed on Jun. 30, 2003, the contents of which are herein incorporated by reference in its entirety for all purposes.

### BACKGROUND OF THE INVENTION

1. Field of the Invention

The invention relates to methods for controlling a gain of a signal received from a communication channel, and to an apparatus for controlling a gain of a signal received from a communication channel.

2. Description of the Related Art

A receiver receives a channel signal transmitted via a channel from a transmitter. In this case, the level of the channel signal is attenuated. A phase of the channel signal received at the receiver may differ from a phase of the channel signal generated from the transmitter. Therefore, the receiver compensates for gain and phase of the channel signal in order to restore the channel signal to the gain and phase of the channel signal as generated from the transmitter.

A conventional receiver compensates the gain of the channel signal using a programmable gain amplifier (PGA). A signal outputted from the PGA is converted into a digital signal by an analog-to-digital converter (A/D converter). In addition, the PGA compensates the gain of the channel signal based on the converted digital signal. An equalizer receives the digital signal from the A/D converter.

However, the digital signal may be substantially affected by a distance between the transmitter and the receiver. An output signal of the A/D converter has non-linear characteristics with respect to the output signal of the PGA. As a result, the gain of the PGA may not be stably controlled, and the equalizer does not provide stable convergence characteristics. In addition, the conventional receiver uses a substantial number of control bits to maintain a constant output level out of the A/D converter.

### SUMMARY OF THE INVENTION

An exemplary embodiment of the present invention is directed to a receiver for controlling a gain of a channel signal. The receiver may include a gain compensating section for compensating a first gain therein based on a first gain control signal and the channel signal to generate a first compensating signal. The receiver may also include an analog-to-digital converter for converting the first compensating signal to a second compensating signal, and an equalizer for varying a given second gain therein based on the second compensating signal, and for generating a gain signal representing the second gain based on the first compensating signal. A gain compensating controller of the receiver may generate the first gain control signal for controlling the first gain based on the gain signal.

Another exemplary embodiment of the present invention is directed to a method of controlling a gain of a channel signal. In the method, a first gain may be compensated based on a first gain control signal and the channel signal, to generate a first compensating signal that represents a compensated first gain. A gain signal representing a second gain may be generated based on the first compensating signal, and the first gain control signal for controlling the first gain may be generated based on the gain signal.

Another exemplary embodiment of the present invention is directed to an apparatus for controlling a gain of a channel signal. The apparatus may include a gain compensation section for compensating a first gain therein based on the channel signal and a first gain control signal, and an equalizer for generating a gain signal based on the first compensating signal. The gain signal may represent a second gain of the equalizer. A gain compensating controller in the apparatus may generate, based on the gain signal, the first gain control signal for compensating the first gain.

Another exemplary embodiment of the present invention is directed to a method of controlling a gain of a channel signal. In the method, a first compensating signal representing a compensated gain of the channel signal may be generated, and a gain signal generated based on the first compensating signal. A gain control signal for controlling the gain of the channel signal may be generated based on the gain signal.

### BRIEF DESCRIPTION OF THE DRAWINGS

The above and other features and advantages of the present invention will become more apparent to those of ordinary skill in the art by describing, in detail, exemplary embodiments thereof with reference to the attached drawings, wherein like elements are represented by like reference numerals, which are given by way of illustration only and thus do not limit the exemplary embodiments of the present invention and wherein:

FIG. 1 is a block diagram illustrating a gain control receiver according to an exemplary embodiment of the present invention.

FIG. 2 is a block diagram illustrating a gain compensating controller according to an exemplary embodiment of the present invention.

FIG. 3 is a block diagram illustrating a comparing section according to an exemplary embodiment of the present invention.

FIG. 4 is a block diagram illustrating a first gain controller according to an exemplary embodiment of the present invention.

FIG. 5 is a block diagram illustrating an equalizer according to an exemplary embodiment of present invention.

FIG. 6A is a block diagram illustrating a first filter according to an exemplary embodiment of the present invention.

FIG. 6B is a schematic view showing the first filter according to an exemplary embodiment of the present invention.

FIG. 7A is a block diagram illustrating a second filter according to another exemplary embodiment of the present invention.

FIG. 7B is a schematic view showing a second filter according to another exemplary embodiment of the present invention.

FIG. 8 is a flowchart illustrating a method of compensating a gain of a channel signal according to an exemplary embodiment of the present invention.

FIG. 9 is a flowchart illustrating a method of compensating a gain of a channel signal according to another exemplary embodiment of the present invention.

FIG. 10 is a flowchart illustrating a method of compensating a gain of a channel signal according to still another exemplary embodiment of the present invention.

FIG. 11 is a flowchart illustrating a method of filtering the inter-symbol interference component according to an exemplary embodiment of the present invention.

### DETAILED DESCRIPTION OF THE EXEMPLARY EMBODIMENTS

The invention now will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be through and complete, and will fully covey the scope of the invention to those of ordinary skill in the art. In drawings, like reference characters refer to like elements throughout.

In general, the exemplary embodiments of the present invention are directed to methods of controlling a gain and to a receiver for controlling a gain therein. The methods and receiver may be capable of stably controlling the gain, irrespective of a control bit number of a programmable gain amplifier (PGA) and of the characteristics of the channels.

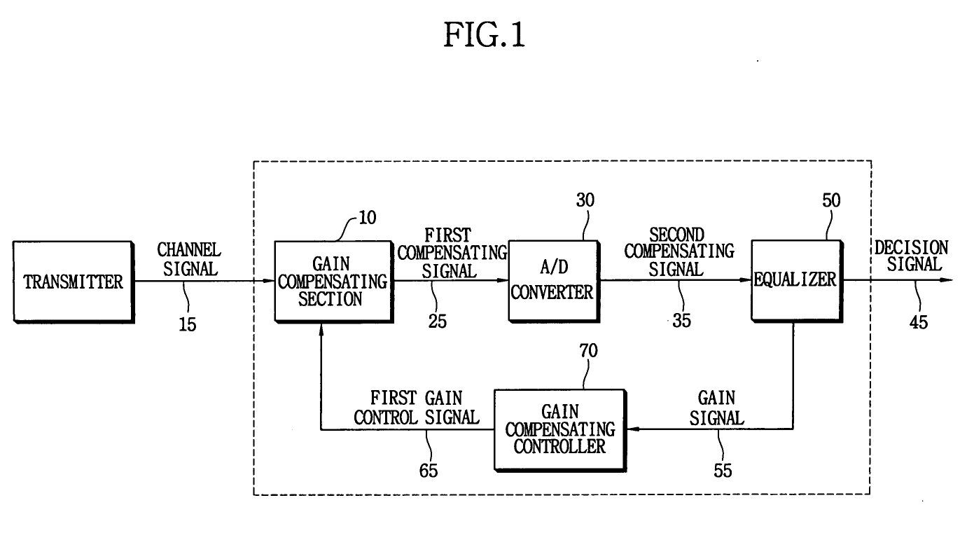

FIG. 1 is a block diagram illustrating a receiver of controlling a gain of a channel signal according to an exemplary embodiment of the present invention. Referring to FIG. 1, the receiver may include a gain compensating section 10. The gain compensating section 10 receives a channel signal 15 and a first gain control signal 65 and compensates a first gain of the gain compensating section 10 so to generate a first compensating signal 25 representing a compensated gain for the channel signal 15. The first compensating signal 25 represents (magnitude of the channel signal×the first gain). The channel signal 15 may represent a signal transmitted from a transmitter via a communication channel, for example. The gain compensating section 10 may include a programmable gain amplifier (PGA) (not shown).

The first gain indicates a gain of the gain compensating section 10, and the channel signal 15 represents a signal transmitted from a transmitter via a communication channel. Generally, when the channel signal 15 is transmitted via the communication channel, the level of the channel signal 15 is attenuated, and an inter-symbol interference (ISI) occurs. As a result, the channel signal 15 may not be restored by the receiver to the exact form that is was transmitted. For example, the information included in the channel signal 15 may not be accurately restored by the receiver. Thus, the channel signal 15 may need compensation.

The gain compensating section 10 thus compensates the level of the channel signal 15, thereby accurately restoring the information included in the channel signal 15. The gain compensating section 10 compensates the level of the channel signal 15 based on the first gain control signal 65, as will be shown in further detail below.

The receiver may also include an analog to digital (A/D) converter 30. The A/D converter 30 is operatively connected to the gain compensating section 10 to receive the first compensating signal 25. The A/D converter 30 converts the first compensating signal 25 (an analog signal) into a second compensating signal 35 (a digital signal).

The receiver may also include an equalizer 50 operatively connected to the A/D converter 30 to receive the second compensating signal 35. The equalizer 50 may vary a given second gain, and may generate a decision signal 45 representing a compensated channel signal. In addition, the equalizer 50 may generate a gain signal 55 representing the second gain, and may filter an ISI component from the second compensating signal 35. Here, the term ‘second gain’ may represent the gain of the equalizer 50. In particular, the equalizer 50 provides the gain compensation section 10 with the given second gain to compensate the channel signal 15. In addition, the equalizer 50 changes the given second gain based on the second compensating signal 35. In other words, the equalizer 50 may gradually vary the second gain, to provide the varied second gain to the gain compensating section 10, thereby compensating the channel signal 15.

Hence, the receiver varies the second gain, and may vary the first gainusing the varied second gain. In other words, the first gain may vary in accordance with the second gain. Thus, the channel signal 1.5 may be compensated based on both the first and second gains.

The receiver may also include gain compensating controller 70 operatively connected to the equalizer 50 to receive the gain signal 55. The gain compensating controller 70 may generate the first gain control signal 65 for controlling the first gain based on the gain signal 55. Accordingly, the receiver may compensate the channel signal 15 based on at least one of the second gain and the first gain, where the first gain may be varied in accordance with the second gain. Therefore, the receiver may be configured to perform a more stable gain control process, as compared to the conventional receiver.

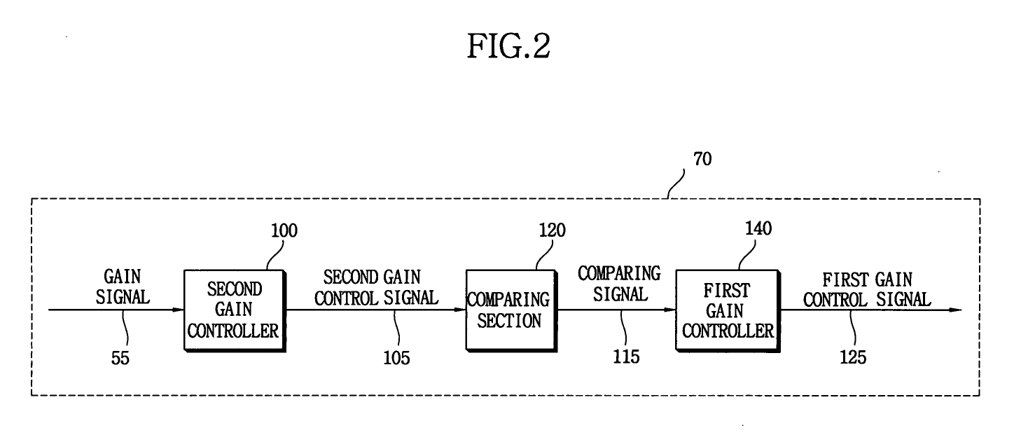

FIG. 2 is a block diagram illustrating a gain compensating controller according to an exemplary embodiment of the present invention. Referring to FIG. 2, the gain compensating controller 70 may include a second gain controller 100, a comparing section 120, and a first gain controller 140. Alternatively, the gain compensating section 70 may include only the comparing section 120 and the first gain controller 140, omitting the second gain controller 100.

The second gain controller 100 may generate a second gain control signal 105 based on the gain signal 55 (the use of ‘second’ and ‘first’ in FIG. 2 are provided for reasons of clarity to distinguish between the gain control signals). The second gain controller 100 filters the ISI component included in the gain signal 55, or approximates the value of the ISI component to about “0” by calculating an average value of the ISI component, for example.

The comparing section 120 compares the second gain to one or more threshold voltages that are based on the second gain control signal 105 to output a comparing signal 115. Alternatively, the comparing section 120 generates the comparing signal 115 based on the gain signal 55. This will be described in further detail below.

The first gain control section 140 generates a first gain control signal 125 for controlling the first gain based on the comparing signal 115. For example, the first gain controller 140 generates the first gain control signal 125 to raise or lower the first gain (first compensating signal 25) based on the comparing signal 115 generated from the comparison of the second gain (gain of equalizer 55) to the threshold voltages.

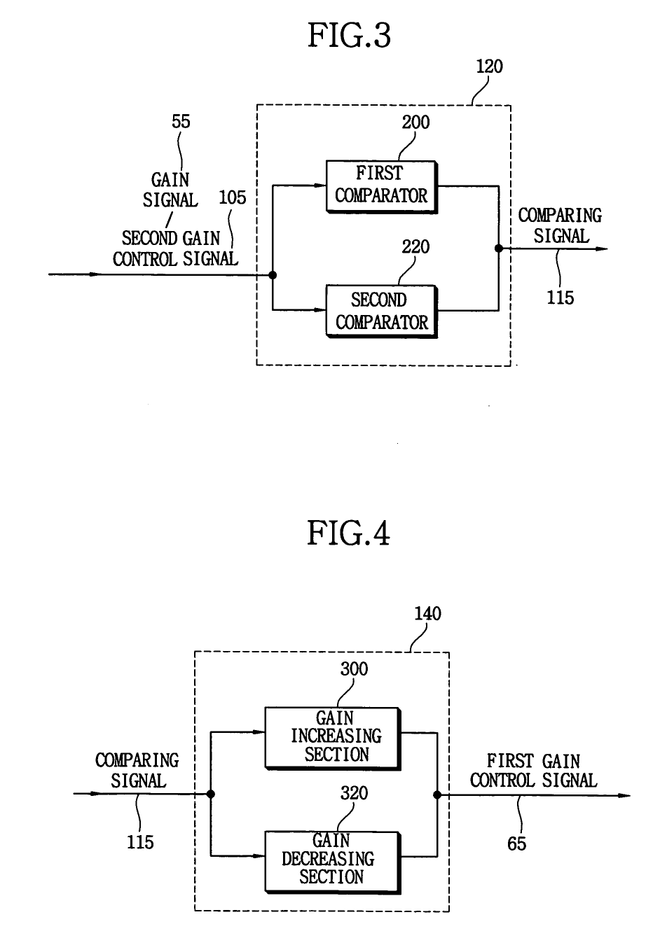

FIG. 3 is a block diagram illustrating a comparing section according to an exemplary embodiment of the present invention. Referring to FIG. 3, the comparing section 120 may include a first comparator 200 and a second comparator 220. The threshold voltages may include an upper threshold voltage and a lower threshold voltage. Generally, the range between the upper and lower threshold voltages may be set to the range of voltages in which the equalizer 50 may operate without error.

If the second gain exceeds the upper threshold voltage, the first comparator 200 generates a comparing signal 115 with gain increase information for increasing the first gain. As a result, the first gain may be raised, and the second gain may be reset to an initial value. In other words, the first gain may vary in accordance with the second gain. The first gain multiplied by the second gain corresponds to a given gain value. In this example, the second gain may be too great a value because the first gain may be too small a value. Therefore, the first gain may be increased. Thus, the first comparator 200 generates the comparing signal 115 having gain increase information for raising the first gain.

If the second gain is lower than the lower threshold voltage, the second comparator 220 generates the comparing signal 115 including gain decrease information for lowering the first gain. As a result, the first gain is lowered, and the second gain is reset to an initial value. In this example, the second gain may be too small because the first gain is too great. Therefore, the first gain may be lowered based on the gain decrease information.

FIG. 4 is a block diagram illustrating a first gain controller according to an exemplary embodiment of the present invention. Referring to FIG. 4, the first gain controller 140 may include a gain increasing section 300. Based on the comparing signal 115 received from comparing section 120, the gain increasing section 300 generates the first gain controlling signal 65. For example, if the second gain exceeds the upper threshold voltage, the gain increasing section 300 generates a first gain controlling signal 65 for increasing the first gain.

The first gain controller 140 may also include a gain decreasing section 320. The gain decreasing section 320 generates the first gain controlling signal 65 for decreasing the first gain based on the comparing signal 115. For example, if the second gain is lower than the lower threshold voltage, the gain decreasing section 320 generates the first gain controlling signal 65 for decreasing the first gain.

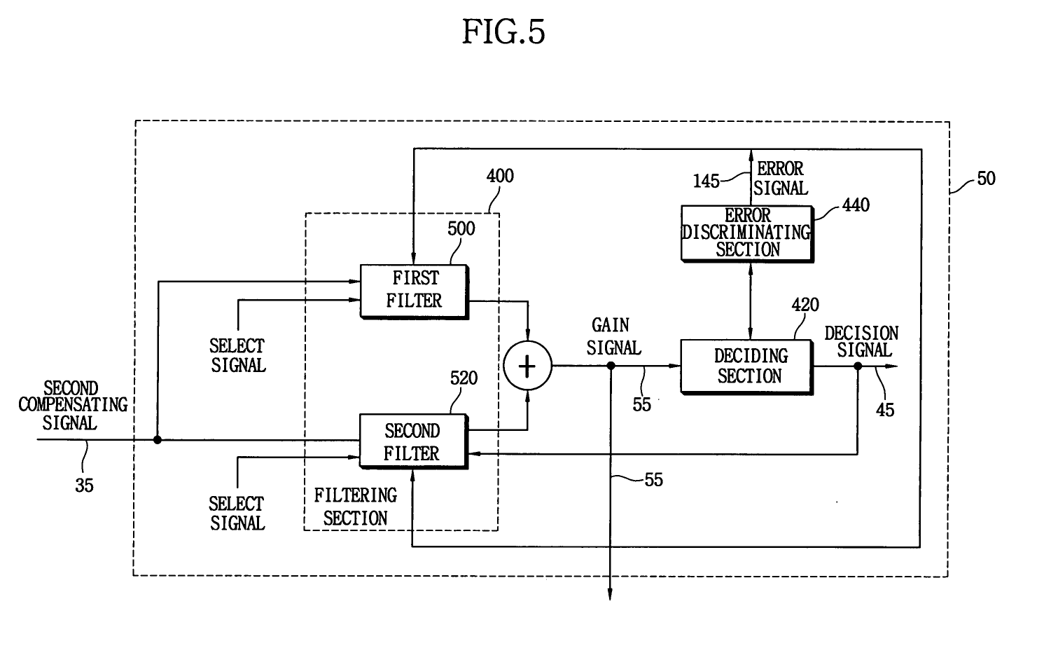

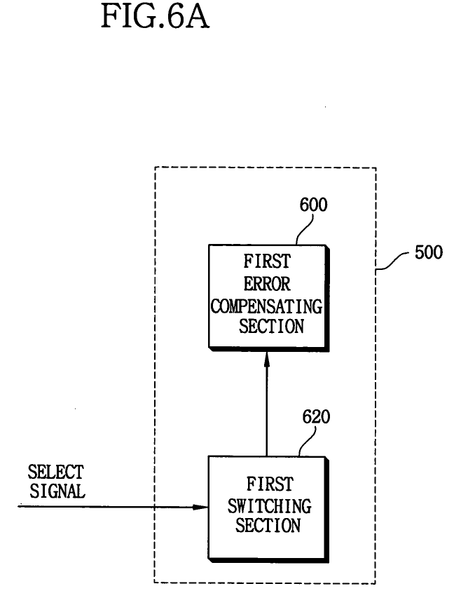

FIG. 5 is a block diagram illustrating an equalizer according to an exemplary embodiment of present invention. Referring to FIG. 5, the equalizer 50 may include a filtering section 400. The filtering section 400 may include a first filter 500.

The filtering section 400 of another exemplary embodiment of the present invention may further include a second filter 520. The filtering section 400 filters the ISI component from the second compensating signal 35 based on an error signal 145, a select signal and the decision signal 45, and varies the second gain. In addition, the filtering section 400 may generate the gain signal 55 that represents the varied second gain. For example, the filtering section 400 filters the ISI component from the second compensating signal 35 and varies the second gain in accordance with the select signal.

Referring to FIG. 5, the first filter 500 may filter the ISI component from the second compensating signal 35 and may vary the second gain based on the select signal and the error signal 145. The second filter 520 may filter the ISI component from the second compensating signal 35 and may vary the second gain based on the select signal and the decision signal 45. For example, the first filter 500 filters a pre-inter-symbol interference (pre-ISI) component and a post-inter-symbol interference (post-ISI) component, and the second filter 520 filters the post-ISI component. The pre-ISI component indicates an ISI due to signals following the second compensating signal 35, and the post-ISI component represents an ISI due to signals prior to the second compensating signal 35.

the equalizer 50 may also include a deciding section 420. The deciding section 420 may generate the decision signal 45 representing a compensated channel transimitting signal that is based on the gain signal 55. For example, the deciding section 420 may generate the decision signal 45 based on a calculating value (a magnitude of level of the channel signal×the first gain×the second gain) that is converged to minimize the difference between the calculating value and a desired value. The desired value may be a given value for the purpose of restoring the channel signal in the form it was transmitted from the transmitter. For example, in a 100BASE-T Ethernet, the desired value may be any of −1, 0, and 1.

Referring again to FIG. 5, the equalizer 50 may further include an error discriminating section 440. The error discriminating section 440 monitors the deciding section 420 to generate the error signal 145. The error signal 145 may include information related to the monitoring of the deciding section 420.

For example, the error discriminating section 440 may compare the gain signal 55 with the decision signal 45 to generate the error signal 145. The error signal 145 may represent the information of the filtered ISI and a converged value of the second gain. In other words, the error discriminating section 440 compares the calculating value with the desired value to discriminate the convergence condition of the second gain. In addition, the error discriminating section 440 may discriminate whether or not the gain signal 55 includes the ISI component, and may generates an error signal 145 representing a result of the discriminating operation.

The select signal may control the filtering section 400. The first filter 500 and the second fiter 520 are respectively switched by the select signal.

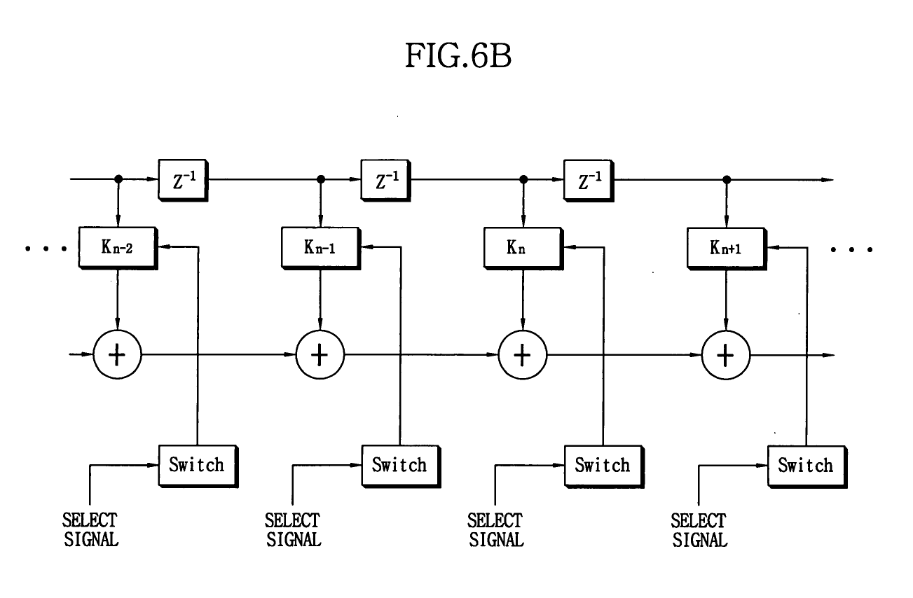

FIG. 6A is a block diagram illustrating a first filter according to an exemplary embodiment of the invention, and FIG. 6B is a schematic view of the first filter. Referring to FIGS. 6A and 6B, the first filter 500 may include a first error compensating section 600. The first error compensating section 600 may be composed of a plurality of delay elements (shown generally in FIG. 6B as Z⁻¹) and a plurality of filter taps. Each of the filter taps may couple between the delay elements. In addition, each of the filter taps may have different filter tap coefficients. The first error compensating section 600 filters the pre-ISI component and the post-ISI component from the second compensating signal 35, and varies the second gain.

For example, the first error compensating section 600 varies the filter tap coefficient of Kₙ and varies the second gain. In other words, the second gain may correspond to the filter tap coefficient of Kₙ (which is the most significant filter tap, hereafter referred to as “MST1”). In addition, the first error compensating section 600 may change the delay elements and the filter tap coefficients of the filter taps, and may filter the pre-ISI component and the post-ISI component from the second compensating signal 35.

The first filter 500 may also include first switching section. The first switching section 620 includes a plurality of switches, as shown in FIG. 6B. The switches are coupled to the respective filter taps. Each of the switches allows the filter taps to switch. For example, when the second gain is varied, the first switching section 620, under the control of select signal, turns on only the filter tap of Kₙ, and turns off the other filter taps. In addition, when the ISI component is filtered, the first switching section 620 turns on the all switches therein.

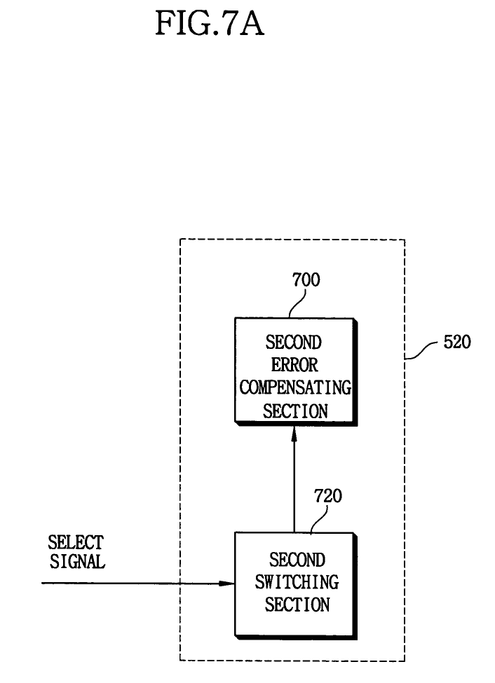

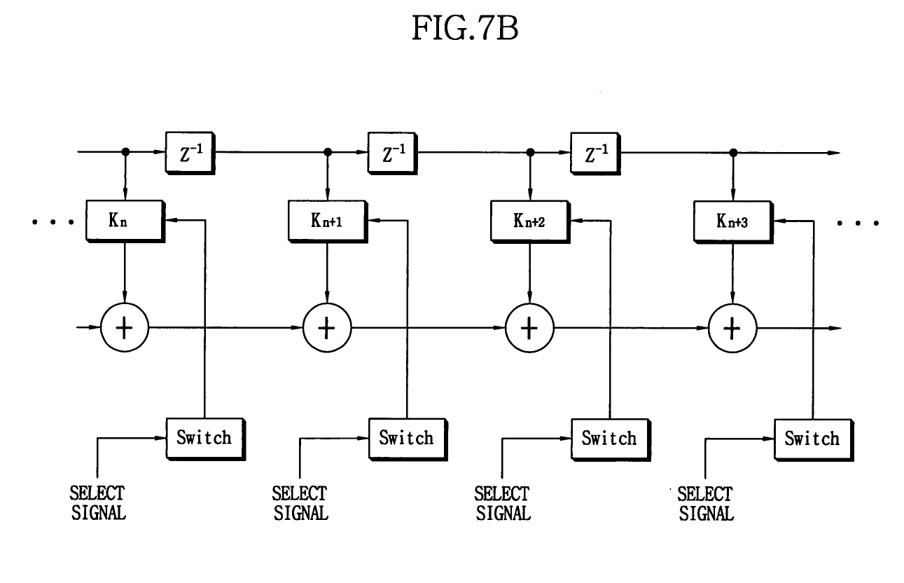

FIG. 7A is a block diagram illustrating a second filter according to another exemplary embodiment of the invention, and FIG. 7B is a schematic view of the second filter. Referring to FIGS. 7A and 7B, the second filter 520 may include a second compensating section 700 and second switching section 720, similar to the structure shown in FIGS. 6A and 6B. Thus, only the differences are discussed in FIGS. 7A and 7B for purposes of brevity.

The second error compensating section 700 filters the post-ISI component from the second compensating signal 35, and varies the second gain. For example, the second error compensating section 700 changes the filter tap coefficient of Kₙ (which is the most significant filter tap, hereafter referred to as “MST2”) of the second filter 520 to the second gain. Here, the second gain may equal to MST1 minus MST2. In addition, the second error compensating section 700 changes the delay elements and the coefficients of the filter taps, and filters the post-ISI component from the second compensating signal 35.

The second switching section 720 includes a plurality of switches, as discussed above. When the second gain is varied, the second switching section 720, based on the select signal, turns on only the filter tap corresponding to MST2, and turns off the other filter taps. In addition, when the ISI component is filtered, the second switching section 720 turns on all switches therein.

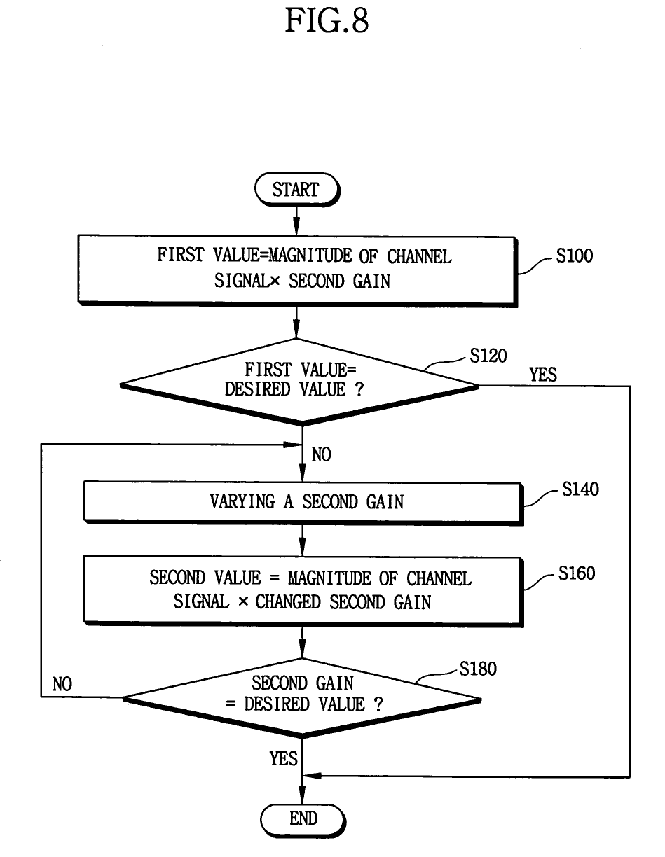

FIG. 8 is a flowchart illustrating a method of compensating a gain of a channel signal according to an exemplary embodiment of the invention. Referring to FIG. 8, a first value may be obtained (function S100) by a calculation of the magnitude of the channel signal×the second gain, in order to compensate the gain. The first value is compared (function S120) with the desired value. If the first value is substantially identical to the desired value (output of function S120 is ‘YES’), the gain compensating operation is terminated. If the first value is not substantially identical to the desired value (output of function S120 is ‘NO’), the second gain may be gradually varied (function S140).

A second value may be obtained (function S160) by a calculation of the magnitude of the channel signal×the varied second gain, where the varied second gain is the second gain varied by function S140. The second value may be compared (function S180) with the desired value. If the second value is substantially identical to the desired value (output of function S180 is ‘YES’), the gain compensating operation is terminated; otherwise function S140, S160 and S180 are repeated to vary the second gain and re-calculate the second value, until the second gain is substantially identical to the desired value, as shown in FIG. 8.

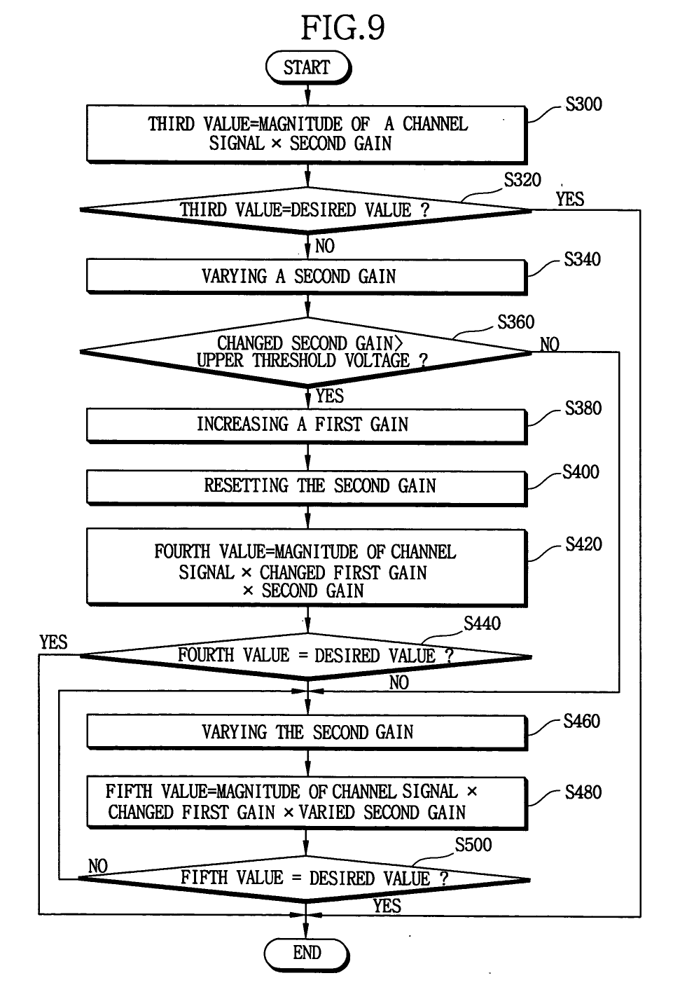

The first and second value calculating functions S100 and S160, and the comparing functions S120 and S180 described in FIG. 8 may be performed by the error discriminating section 440, and the varying function S140 may be performed in the filtering section 400 of the equalizer 50, as discussed above FIG. 9 is a flowchart illustrating a method of compensating a gain of a channel signal according to another exemplary embodiment of the present invention. Similar to FIG. 8, the functions described below may be performed by the error discriminating section 440, and filtering section 400 of the equalizer 50, with the desired value provided by the deciding section 420 of the equalizer 50. In FIG. 9, third, fourth and fifth values are described for reasons of clarity, so as to distinguish these values from the first and second values of FIG. 8.

Referring to FIG. 9, functions S300, S320 and S340 substantially correspond to functions S100, S120 and S140 of FIG. 8, so only differences are explained in detail here for reasons of brevity. If the third value does not equal the desired value to terminate the gain compensation operation (output of function S320 is ‘NO’), the second gain may be changed gradually (i.e., from 1 to 1.1, 1.1 to 1.2, 1.2 to 1.3, etc), (function S340).

The changed second gain may be compared (function S360) with the upper threshold voltage. If the changed second gain does not exceed (e.g., less than or equal to) the upper threshold voltage (output of function S360 is ‘NO’), the second gain may be further gradually changed (function S460), as shown in FIG. 9. In this example, the first gain corresponds to 1.

If the changed second gain is greater than the upper threshold voltage (output of function S360 is ‘YES’), a level of the first gain may be increased (function S380) by one level, such as from 1 to 1.1, for example. The second gain is then reset (function S400) to the initial value, and a fourth value is calculated (function S420). The fourth value may be calculated based on a magnitude of the channel signal×the changed first gain×the second gain, as shown in FIG. 9. The second gain in this calculation is the second gain as reset by function S400.

The fourth value is compared (function S440) with the desired value. If the fourth value substantially equals the desired value (output of function S440 is ‘YES’), the gain compensating operation is complete and is terminated. Otherwise, the second gain is changed gradually (function S460).

A fifth value is calculated (function S480). The fifth value may be obtained by calculating magnitude of the channel signal×the changed first gain×the varied second gain). The second gain in this calculation is the second gain as changed by function S460. The fifth value is compared (function S500) with the desired value. If the fifth value is substantially identical to the desired value (output of function S500 is ‘YES’), the gain compensating operation is finished. Otherwise, functions S460, S480 and S500 are repeated, making gradual changes to the second gain an re-calculating the fifth value, until the fifth value is substantially similar to the desired value.

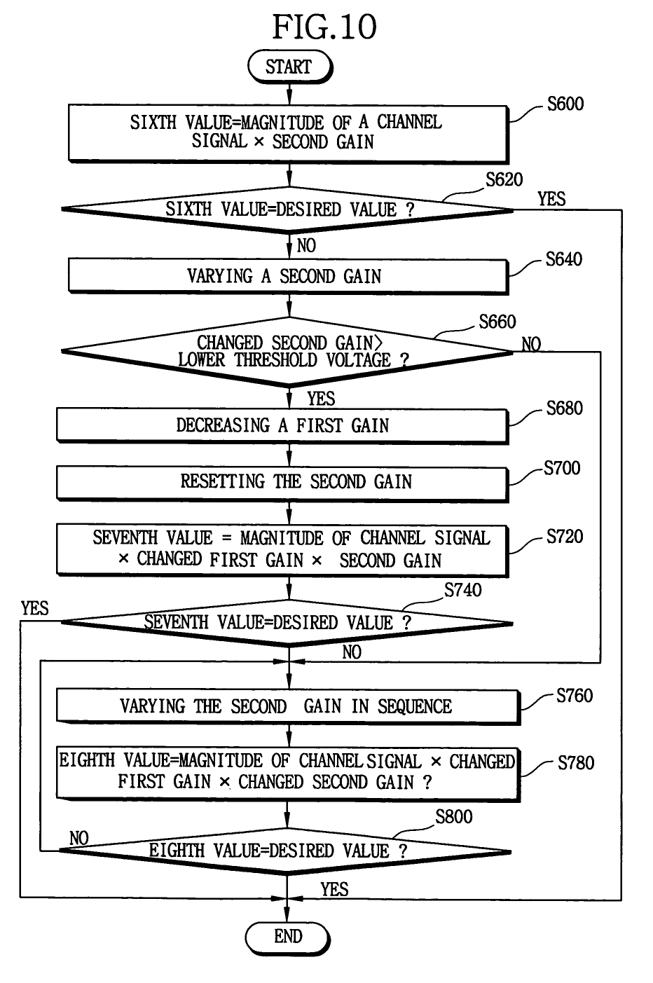

FIG. 10 is a flowchart illustrating a method of compensating a gain of a channel signal according to another exemplary embodiment of the present invention. Functions shown FIG. 10 are substantially similar to the functions described in FIG. 9, thus the differences are highlighted for reasons of brevity. In FIG. 10, sixth, seventh and eight values are described so as to distinguish these values from the first through fifth values of FIGS. 8 and 9.

Referring to FIG. 10, functions S600, S620, S640 and S660 are identical to FIG. 9, with the exception that in function S660 the changed second gain is compared to the lower threshold voltage instead of the upper threshold voltage. If the changed second gain is less than or equal to the lower threshold voltage (output of function S660 is ‘NO’), the changed second gain is further gradually changed in sequence (function S760). Otherwise, if the changed second gain exceeds the lower threshold voltage, a level of the first gain (in this example, first gain=1) is decreased (function S680) by one level, and the second gain is reset (function S700) to the initial value.

Functions S720, S740, S760, S780 and S800 in FIG. 10 are substantially similar to functions S420, S440, S460, S480 and S500 in FIG. 9, thus only the differences are highlighted for brevity. Referring to FIG. 10, if the seventh value is not substantially identical to the desired value output of function S740 is ‘NO’), the second value is changed in sequence (function S760). The eighth value calculated at function S780 is calculated using the changed second gain from function S760, in addition to the magnitude of the channel signal and the changed first gain, as shown in FIG. 10. Similar to FIG. 9, the gain compensating operation is completed if the eighth value is substantially similar to the desired value (output of function S800 is ‘YES’), otherwise functions S760, S780 and S800 are repeated, making gradual changes to the second gain in sequence, and re-calculating the eighth value, until the eighth value is substantially similar to the desired value.

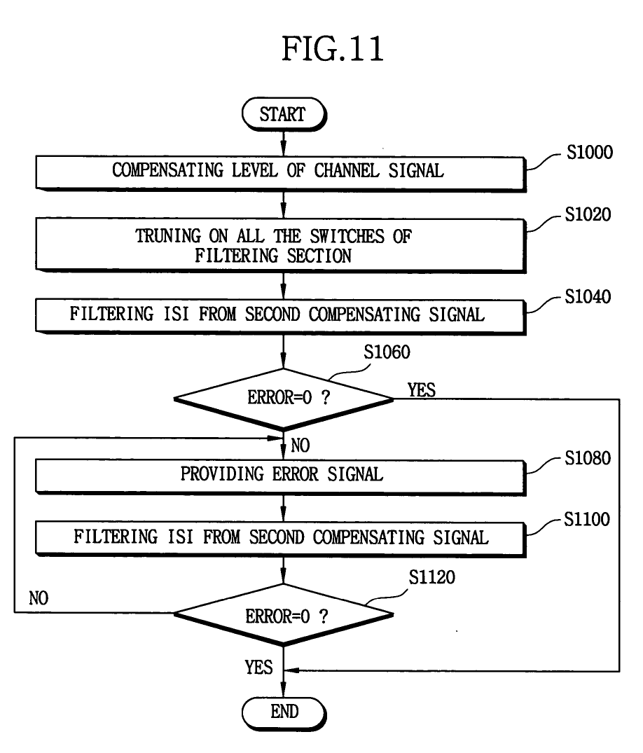

FIG. 11 is a flowchart illustrating a method of filtering the inter-symbol interference component according to an exemplary embodiment of the invention. Referring to FIG. 11 a level (i.e., gain) of the channel signal 15 is compensated (function S1000) and all the switches of the filtering section 400 are turned on (function S1020) once the gain compensating operation is completed. The filtering section 400 filters (function S1040) the ISI component from the second compensating signal 35.

Next, it is discriminated (function S1060) whether or not the ISI component is completely filtered from the second compensating signal 35. If the error signal 145 equals zero (i.e., no error signal present, output of function S1060 is ‘YES’), the filtering operation for filtering the ISI component from the second compensating signal 35 is complete and is terminated. Otherwise, the second compensating signal 35 includes the ISI component (output of function S1060 is ‘NO’) and an error signal 145 is provided (function S1080).

The filtering section 400 filters (function S1100) the ISI component from the second compensating signal 35 in order to filter the ISI component remaining in the second compensating signal 35. It is then discriminated whether or not the ISI component is completely filtered from the second compensating signal 35 (function S1120). The filtering operation is finished if the filtering section 400 has completely filtered the ISI component from the second compensating signal 35, otherwise function S1080, S110 and S1120 are repeated until any remaining ISI component has been filtered.

According to the exemplary embodiments of the present invention, the receiver controls the gain of the gain compensating section 10 using the most significant filter tap (MST) of the equalizer 50. Thus the gain may be stably controlled, regardless of the number of the control bits of a gain compensating section 10 and characteristics of the channel. In addition, the receiver may vary the gains of the equalizer 50 and gain compensating section 10 such that the gain of the equalizer 50 has a given relationship with the gain of the gain compensating section 10, potentially enhancing convergence characteristics of the equalizer.

The exemplary embodiments of the present invention being thus described, it will be obvious that the same may be varied in many ways. Such variations are not to be regarded as departure from the spirit and scope of the exemplary embodiments of the present invention, and all such modifications as would be obvious to one skilled in the art are intended to be included within the scope of the following claims.

What is claimed is:

1. A receiver for controlling a gain of a channel signal, comprising:
a gain compensating section for compensating a first gain therein based on a first gain control signal and the channel signal to generate a first compensating signal;
an analog-to-digital converter for converting the first compensating signal to a second compensating signal;
an equalizer for varying a given second gain therein based on the second compensating signal, and for generating a gain signal representing the second gain based on the first compensating signal; and
a gain compensating controller for generating the first gain control signal for controlling the first gain based on the gain signal.

2. The receiver of claim 1, wherein the gain compensating controller includes:
a comparing section for comparing the second gain with at least one threshold voltage that is based on the gain signal to generate a comparing signal; and
a first gain controller that for generating the first gain control signal based on the comparing signal.

3. The receiver of claim 1, wherein the gain compensating controller includes:
a second gain controller for substantially removing noise from the gain signal to generate a second gain control signal;
a comparing section for comparing the second gain to at least one threshold voltage that is based on the second gain control signal to generate a comparing signal; and
a first gain controller for generating the first gain control signal based on the comparing signal.

4. The receiver of claim 3, wherein the at least one threshold voltage includes an upper threshold voltage and a lower threshold voltage.

5. The receiver of claim 4, wherein the comparing section includes:
a first comparator for generating the comparing signal to include first information for increasing the first gain, if the second gain exceeds the upper threshold voltage; and
a second comparator for generating the comparing signal to include second information for decreasing the first gain, if the second gain is less than the lower threshold voltage.

6. The receiver of claim 5, wherein the first gain controller includes:
a gain increasing section for generating the first gain control signal for increasing the first gain based on the comparing signal with first information; and
a gain decreasing section for generating the first gain control signal for decreasing the first gain based on the comparing signal with second information.

7. The receiver of claim 1, wherein the equalizer includes:
a filtering section for filtering an inter-symbol interference component from the second compensating signal based on an error signal, a select signal and a decision signal, for varying the second gain, and for generating the gain signal with the varied second gain;
a deciding section for generating the decision signal based on the gain signal, the decision signal represents a compensated channel signal; and
an error discriminating section for monitoring the deciding section to generate the error signal.

8. The receiver of claim 7, wherein the inter-symbol interference component includes a pre-inter-symbol interference component and a post-inter-symbol interference component.

9. The receiver of claim 8, wherein
the error signal is generated based on a monitored result of the deciding section,
the monitored result includes a result of a comparison between a calculating value and the desired value, and
the calculating value is calculated by an expression (magnitude of the channel signal×the first gain×the second gain).

10. The receiver of claim 9, wherein the filtering section includes:
a first filter for filtering the pre-inter-symbol interference component and the post-inter-symbol interference component from the second compensating signal, and for varying the second gain; and
a second filter for filtering the post-inter-symbol interference component from the second compensating signal, and for varying the second gain.

11. The receiver of claim 10, wherein the first filter includes:
a first error compensating section for filtering the inter-symbol interference component from the second compensating signal, and for varying the second gain; and
a first switching section for controlling the first error compensating section based on the select signal.

12. The receiver of claim 10, wherein the second filter includes:
a second error compensating section for filtering the post-inter-symbol interference component from the second compensating signal, and for varying the second gain; and
a second switching section that for controlling the second error compensating section based on the select signal.

13. The receiver of claim 10, wherein each of the first filter and the second filter includes:
a plurality of delay elements coupled in parallel relation to one another;
a plurality of filter taps coupled between the delay elements; and
a plurality of switches coupled to the corresponding filter taps.

14. The receiver of claim 13, wherein
the filter taps are coupled between corresponding delay elements,
the second gain is obtained based on coefficients of the filter taps, and
the switches control the coefficients of the filter taps.

15. A method of controlling a gain of a channel signal, comprising:
compensating a first gain based on a first gain control signal and the channel signal;
generating a first compensating signal representing a compensated first gain;
generating a gain signal representing a second gain based on the first compensating signal; and
generating the first gain control signal for controlling the first gain based on the gain signal.

16. The method of claim 15, further comprising:
generating a decision signal representing the compensated channel signal based on the first compensating signal.

17. The method of claim 16, wherein generating the gain signal further includes:
converting the first compensating signal, received as an analog signal, into a corresponding digital second compensating signal; and
generating the decision signal based on the second compensating signal.

18. The method of claim 16, wherein generating the gain signal further includes:
converting the first compensating signal, received as an analog signal, into a corresponding digital second compensating signal;
varying a given second gain based on the second compensating signal; and
generating the gain signal representing the varied second gain.

19. The method of claim 15, wherein generating the first gain control signal further includes:
comparing the second gain with at least one threshold voltage that is based on the gain signal;
generating a comparing signal based on the comparison; and
generating the first gain control signal based on the comparing signal.

20. The method of claim 15, wherein generating the first gain control signal further includes:
substantially removing noise from the gain signal to generate a second gain control signal;
comparing the second gain to at least one threshold voltage that is based on the second gain control signal;
generating a comparing signal based on the comparison; and
generating the first gain control signal based on the comparing signal.

21. The method of claim 20, wherein the at least one threshold voltage includes an upper threshold voltage and a lower threshold voltage.

22. The method of claim 21, wherein generating the comparing signal further includes:
generating the comparing signal to include first information for increasing the first gain, if the second gain exceeds the upper threshold voltage; and
generating the comparing signal to include second information for decreasing the first gain, if the second gain is less than the lower threshold voltage.

23. The method of claim 20, wherein generating the first gain control signal further includes:
generating the first gain control signal for increasing the first gain based on the comparing signal with the first information; and
generating the first gain control signal for decreasing the first gain based on the comparing signal with the second information.

24. The method of claim 18, wherein varying the second gain further includes:
filtering an inter-symbol interference component from the second compensating signal based on an error signal, a select signal and the decision signal; and
varying the second gain based on the error signal, the select signal and the decision signal.

25. The method of claim 24, wherein the second gain is further varied by:
monitoring the second gain; and
generating the error signal representing the monitoring of the second gain.

26. The method of claim 24, wherein the inter-symbol interference component includes a pre-inter-symbol interference component and a post-inter-symbol interference component.

27. The method of claim 26, wherein
the error signal is generated based on a monitored result of the deciding section,
the monitored result includes a result of a comparison between a calculating value and the desired value, and
the calculating value is calculated by an expression (magnitude of the channel signal×the first gain×the second gain).

28. The method of claim 26, wherein filtering of the inter-symbol interference component further includes:
filtering the pre-inter-symbol interference component and the post-inter-symbol interference component from the second compensating signal; and
filtering the post-inter-symbol interference component from the second compensating signal.

29. A method of controlling a gain of a channel signal, comprising:
compensating a first gain based on a first gain control signal and the channel signal to generate a compensated first gain;
generating a first compensating signal representing the compensated first gain;
generating a gain signal representing a second gain based on the first compensating signal;
generating the first gain control signal for controlling the first gain based on the gain signal;
determining a calculating value based on an expression (magnitude of the channel signal×the first gain×the second gain);
comparing the calculating value with a desired value; and
filtering an inter-symbol interference component from the first compensating signal based on the comparison.

30. The method of claim 29, wherein filtering the inter-symbol interference component further includes:
converting the first compensating signal, received as an analog signal, into a corresponding digital second compensating signal;
switching a plurality of switches based on a result of the comparison; and
filtering the inter-symbol interference component from the second compensating signal in accordance with the switching.

31. An apparatus for controlling a gain of a channel signal, comprising:
a gain compensation section for compensating a first gain therein based on the channel signal and a first gain control signal;
an equalizer for generating a gain signal based on the first compensating signal, the gain signal representing a second gain therein; and
a gain compensating controller for generating, based on the gain signal, the first gain control signal for compensating the first gain.

32. The apparatus of claim 31, wherein the gain compensating controller includes:
a comparing section for comparing the second gain with at least one threshold voltage that is based on the gain signal to generate a comparing signal; and
a first gain controller that for generating the first gain control signal based on the comparing signal.

33. The apparatus of claim 31, wherein the gain compensating controller includes:
a second gain controller for substantially removing noise from the gain signal to generate a second gain control signal;
a comparing section for comparing the second gain to at least one threshold voltage that is based on the second gain control signal to generate a comparing signal; and
a first gain controller for generating the first gain control signal based on the comparing signal.

34. The apparatus of claim 33, wherein the at least one threshold voltage includes an upper threshold voltage and a lower threshold voltage.

35. A method of controlling a gain of a channel signal, comprising:
generating a first compensating signal representing a compensated gain of the channel signal;
generating a gain signal based on the first compensating signal; and
generating a gain control signal for controlling the gain of the channel signal based on the gain signal.

36. A receiver for performing the method of claim 15 to control gain of a channel signal.

37. An apparatus for performing the method of claim 15 to control gain of a channel signal.

38. A receiver for performing the method of claim 35 to control gain of a channel signal.

39. An apparatus for performing the method of claim 35 to control gain of a channel signal.

40. A method representing operation of the receiver of claim 1 for controlling gain of a channel signal.

41. A method representing operation of the apparatus of claim 31 for controlling gain of a channel signal.
